(19) United States
(12) Patent Application Publication
(10) Pub. No.: US 2005/0285350 A1
(43) Pub. Date: Dec. 29, 2005

(54) PTFE sealing device

(76) Inventor: Lourenco Agnello Oricchio JR., Sao Paulo (BR)

Correspondence Address: ARENT FOX PLLC, 1050 CONNECTICUT AVENUE, N.W., SUITE 400, WASHINGTON, DC, 20036, US

(21) Appl. No.: 11/075,733

(22) Filed: Mar. 10, 2005

(30) Foreign Application Priority Data
May 28, 2004 (BR) PI 0402110-0

(51) Int. Cl. A47D 11/00; F16J 15/32

(52) U.S. Cl. 277/549

(57) ABSTRACT

A sealing device to be used with automotive parts provided with a main PTFE sealing device originally provided with a sufficient amount of rubber material to seal the interstices defined between the sealing surface of the PTFE element and the surface to be sealed to prevent air passage during the engine sealing test applied to the sealing device, wherein the test is conducted by injecting air into the engine.

### BACKGROUND OF THE INVENTION

### Field of the Invention

The present invention refers to f a sealing device belonging to the auto part field, particularly the PTFE sealing device, which was improved for meeting test requirements concerning the sealing of internal combustion engines.

The PTFE retainer is already known, applied to internal combustion engines for sealing, for instance, the interstice between the crankshaft and the crankcase opening or other, formed, in essence: by an annular casing; a main polytetrafluoroethylene sealing element (“PTFE”), based on the casing and which seals against the shaft; and, by an ancillary rubber sealing element for preventing grime from entering the sealing area.

As a rule, after the assembly of an internal combustion engine is completed, including the assembly of the sealing system, a sealing test for the engine is conducted. Such a test generally comprises the air injection into the engine and the checking, through proper means, of possible leakages. It happens that the PTFE sealing elements are relatively rigid, and for that reason, they are accommodated around the shaft or other surfaces to be sealed, leaving narrow interstices through which the lubricating oil from the engines does not leak under regular use, but through which the air employed in the test escapes. Thus, sealing test results are negative, even if the PTFE retainer provides proper sealing for the oil. It is not desirable.

On the other hand, the sealing test may show leakages construed as PTFE retainers' predictable leakages. Notwithstanding, other leaking points arising, for instance, from fissure or porosity in the crankcase, may exist, or other factors that cannot be so detected mask the tests and jeopardize their final result.

### SUMMARY OF THE INVENTION

One aspect of the present invention is to provide a PTFE sealing device that overcomes the problems normally generated by such a type of sealing in internal combustion engine sealing tests as provided for above.

Another aspect of the present invention is to provide a PTFE sealing device, that despite of overcoming the problem above, is not, for such a reason, constructed and/or manufactured with complexity levels that make it an uninteresting one as compared to the conventional model.

Another aspect of the present invention is to provide a PTFE sealing device of proper cost in comparison to its peers.

Therefore, in the view of the aforementioned matters, and intending to overcome them, and in order to achieve the related purposes, the improvement in a PTFE sealing device was developed which consists of originally providing the PTFE sealing element, at least as regards its portion that serves as a sealing against the shaft or other surface, in a thin layer of rubber-type material proper for providing sealing against the passage of air in the sealing test and proper for being removed upon engine first run without prejudice to its lubricant oil sealing provided by the PTFE element.

Such an embodiment of the PTFE sealing device overcomes the problems usually observed in such a kind of sealing upon the sealing test conducted in the engine where it is fixed, as aforementioned, once said rubber-type material layer is enough for sealing air passage, avoiding thereby test jeopardy, and for being removed upon engine first run, from which the PTFE element starts to seal on an a usual basis.

Notwithstanding the aforementioned advantage provided by the sealing device in accordance with this invention, it has also the advantage of being not constructed or manufactured with complexity and/or difficulty and/or cost levels that make it improper in comparison to conventional PTFE retainers.

### BRIEF DESCRIPTION OF THE DRAWINGS

FIG. 1 is a cross-sectional view of the present invention according to a preferred embodiment.

### DETAILED DESCRIPTION OF THE INVENTION

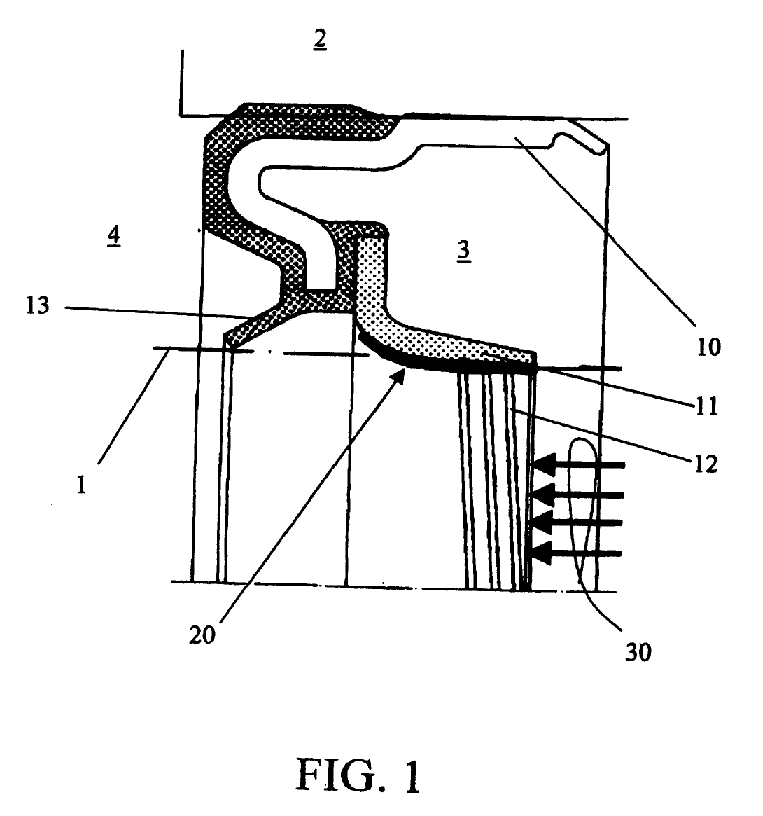

FIG. 1 shows, by way of illustration only and on a non-restrictive basis, a PTFE sealing device, of the present invention in which a detail of a retainer section is seen as it is originally manufactured, and the indication of how its rubber-type material layer seals the surface to be sealed during the sealing test.

As illustrated by the aforementioned figure, the sealing device subject matter of the present invention is intended to seal the interstice between, for instance, the end of a crankshaft 1 and the crankcase opening 2 receiving said end, providing thereby the insulation between the inner 3 and outer 4 environment of the engine or other items, and, in one event and embodiment, it is a retainer (pursuant to the figure attached) essentially comprehended: by an annular casing 10; by a main polytetrafluoroethylene sealing element (“PTFE”) 11 based on the casing, and which serves as a sealing to said surface 1, whose sealing surface may be provided with a hydrodynamic sealing groove 12; and by ancillary rubber or comparable sealing element(s) 13, which protect(s) the sealing region against incoming grime.

In this improvement, the main PTFE sealing element 11, or at least its portion that serves as a sealing against surface to be sealed 1, is originally provided with the application of a thin rubber-type material layer 20 enough for sealing eventual interstices defined between the PTFE sealing element surface 11 and the surface to be sealed 1, in order to provide sealing enough for preventing the passage of air 30 between the inner 3 and the outer 4 environment, or in the retainer inverted assembly embodiment that shall pass between engine outer 3 and the inner 4 environment during its sealing test.

Thus, the retainer, in accordance with this invention, operates as follows:

When it is first fixed to the place of use, the rubber-type material layer 20 incorporated in the sealing portion of the PTFE sealing element 11 seals, against the surface to be sealed, such as the end of a crankshaft 1, providing a sealing level enough for preventing the passage of air 30 during the engine sealing test where the retainer is used, and a more accurate final result for the test as well. In shaft(s) 1 first run, upon engine startup, the rubber-type material layer 20 is removed by attrition and the sealing surface for the PTFE element 11 starts to seal, on the customary basis, directly against the shaft surface, providing a sealing level proper to avoid lubricating oil leakage between engine inner 3 and outer 4 environments, all without prejudice to the system.

In the aforementioned basic embodiment, the PTFE sealing device the present invention may have changes related to materials, dimensions, construction and/or embodiment details, without escaping from the scope of the requested protection.

Thus, this improvement, instead of being applied to a retainer, may be applied to an integrated sealing system, for instance, for sealing between the shaft and the crankcase and/or the Carter flange and/or others, in accordance with the object of other patents of the same applicant.

The sealing layer against the rubber-type material air passage 20 may be made of rubber, as it is known, paint, silicone, elastomeric material or other items used in automotive sealing.

1. A PTFE sealing device comprehended by a retainer or sealing integrated system comprising:
an annular casing;
a main polytetrafluoroethylene (PTFE) sealing element disposed (“PTFE”) on the casing and which seals against a shaft to be sealed wherein a surface of the main PTFE sealing element is provided with a hydrodynamic sealing grooved; and
sealing elements that protect the sealed shaft against incoming grime, or which provide all of the sealing required to an area where the sealing device is used,
wherein the main PTFE sealing element is provided with a thin layer of rubber material that seals interstices defined between the surface of the PTFE sealing element and a surface of the sealed shaft to prevent air passage during an engine sealing test conducted by injecting air into the engine.

2. The device in accordance with claim 1, wherein the sealing rubber material layer during the sealing test, is obtained from one of rubber, silicone, paint, and an elastomer.

3. The device in accordance with claim 1, wherein the sealing elements are rubber.
